(19) United States
(12) Patent Application Publication
(10) Pub. No.: US 2011/0318718 A1
(43) Pub. Date: Dec. 29, 2011

(54) BARTENDING KIT AND METHOD

(75) Inventors: Howard R. Duffy, III, Hamilton, NJ (US); James P. Duffy, Hamilton, NJ (US); Matthew O. Hyland, Hamilton, NJ (US)

(73) Assignee: HAPPY HOUR AT HOME, LLC, Hamilton, NJ (US)

(21) Appl. No.: 13/118,869

(22) Filed: May 31, 2011

Related U.S. Application Data
(63) Continuation of application No. 11/068,354, filed on Feb. 28, 2005, now abandoned.
(60) Provisional application No. 60/548,318, filed on Feb. 27, 2004.

(51) Int. Cl. G09B 19/00

(52) U.S. Cl. 434/127

(57) ABSTRACT

The present invention is a kit and method allowing a user to make a multitude of mixed drinks from a limited amount of drinkable alcohol. The kit includes various standard bartending tools and an instruction set for teaching the user how to make mixed drinks. The present invention reduces the costs associated with stocking a personal bar, while also simplifying the learning of mixology.

### CROSS-REFERENCE TO RELATED APPLICATIONS

This application is a continuation of U.S. application Ser. No. 11/068,354 filed Feb. 28, 2005, which claims the benefit of the filing date of U.S. Provisional Patent Application No. 60/548,318 filed Feb. 27, 2004, the disclosures of which are hereby incorporated herein by reference.

### BACKGROUND OF THE INVENTION

Most people who enjoy entertaining friends at social gatherings are not professional bartenders, and thus do not know the art of making many different cocktails. Although it is not difficult to learn how to make good cocktails, it is a daunting task for most people who are not properly trained in the art of mixology. As a skilled painter can wield his brush and create beautiful art, a skilled bartender can mix his alcohol to create wonderful libations. However, like in most arts, the skills of mixology are learned through years of study and practice.

While practice is something that is up to the sole discretion of the individual, not everyone has the time or money to attend a comprehensive mixology academy, or bartending school. Likewise, not everyone has the means to amass all of the liquors and tools necessary to create the various drinks (i.e. properly stocking a bar). Prior “at home” mixology classes have attempted to solve these individual problems, but have not succeeded in both quickly teaching the art and providing an individual the ability to mix the most popular drinks with a minimal cache of alcohol. Therefore, there exists a need for a way to efficiently instruct an individual in the art of bartending, while utilizing the least amount of liquors and bartending tools.

### BRIEF SUMMARY OF THE INVENTION

The present invention relates to a kit and method for teaching the art of mixology. More particularly, the present invention allows a user to create a plurality of drinks utilizing a minimal number of bottles of liquor.

As used herein, the term mixology refers to the study or skill of preparing mixed drinks. Mixology typically involves mixing more than one ingredient together to prepare a mixed drink. At least one of the ingredients utilized to prepare the mixed drink may be a drinkable alcohol, and the other ingredients may be non-alcoholic liquids, fruits, powdered ingredients, ice, or any other ingredient known in the art. Furthermore, mixology may involve the use of various tools for preparing the mixed drinks.

A first aspect of the present invention is a method of teaching mixology. A preferred method includes providing a plurality of bottles of drinkable alcohol, and providing instruction on the preparation of a quantity of mixed drinks using the bottles of drinkable alcohol. A quantity of mixed drinks may be prepared that is at least four times the quantity of bottles of drinkable alcohol.

In another preferred method, the quantity of mixed drinks is at least six times the amount of bottles of drinkable alcohol. In yet another preferred method, the quantity of mixed drinks is at least ten times the quantity of bottles of drinkable alcohol. In certain preferred embodiments of the above aspect, the method includes providing six bottles of drinkable alcohol, selected from the group consisting of vodka, gin, tequila, rum, bourbon and triple sec.

Another preferred method of teaching mixology includes providing six bottles of drinkable alcohol, and providing instruction on the preparation of a large quantity of mixed drinks using the six bottles of drinkable alcohol. The quantity of mixed drinks may be least four times that of the quantity of the bottles of drinkable alcohol. Alternatively, the quantity of mixed drinks may be at least six times that of the quantity of the bottles of drinkable alcohol. The quantity of mixed drinks may also be at least ten times that of the quantity of the bottles of drinkable alcohol.

In the various embodiments of the present invention, the bottles of drinkable alcohol are preferably selected from the group consisting of vodka, gin, tequila, rum, bourbon, and triple sec. In other embodiments, more or less bottles of drinkable alcohol can be employed. Further, different types of drinkable alcohol can be utilized in preparing a vast quantity of mixed drinks.

A second aspect of the present is a mixology teaching kit. In a preferred embodiment, the mixology teaching kit includes an instruction set for teaching a student to prepare a large quantity of mixed drinks, and at least one mixology tool. Preferably, the instructions are used to prepare a quantity of mixed drinks utilizing no more than six bottles of drinkable alcohol. In certain preferred embodiments, the quantity of mixed drinks is approximately ten times the quantity of the bottles of drinkable alcohol. In other preferred embodiment, the quantity of mixed drinks is approximately six times the quantity of bottles of drinkable alcohol. In yet further preferred embodiments, the quantity of mixed drinks is approximately four times the quantity of bottles of drinkable alcohol.

The at least one mixology tool may be a margarita salter, a mixing tin, a jigger, an ice scoop, a strainer, a pour spout, a bar mat, an ice bag, a bar towel, or a napkin caddy. However, as one of ordinary skill in the art will no doubt recognize, other mixology tools can also be utilized. In another preferred embodiment, the instruction set can be a visual instruction set, including written material and audio/visual material or the like.

In certain preferred embodiments, the mixology teaching kit of this embodiment further includes a audio/visual instruction set, a drink menu, an ingredient list, a quick reference sheet for instruction on making mixed drinks, a margarita salter, a mixing tin, at least on jigger, an ice scoop, a strainer, at least one pour spout, a bar mat, an ice bag, a bar towel, and a napkin caddy.

The above method and features of the present invention will be better understood when considered in conjunction with the following detailed description of non-limiting embodiments thereof, and on examining the accompanying drawings.

### BRIEF DESCRIPTION OF THE DRAWINGS

FIG. 1 is a perspective view of a mixology teaching kit according to one embodiment of the present invention.

### DETAILED DESCRIPTION

In describing the preferred embodiments of the subject matter illustrated and to be described with respect to the drawings, specific terminology will be resorted to for the sake of clarity. However, the invention is not intended to be limited to the specific term so selected, and is to be understood that each specific term includes all technical equivalence which operate in a similar manner to accomplish a similar purpose.

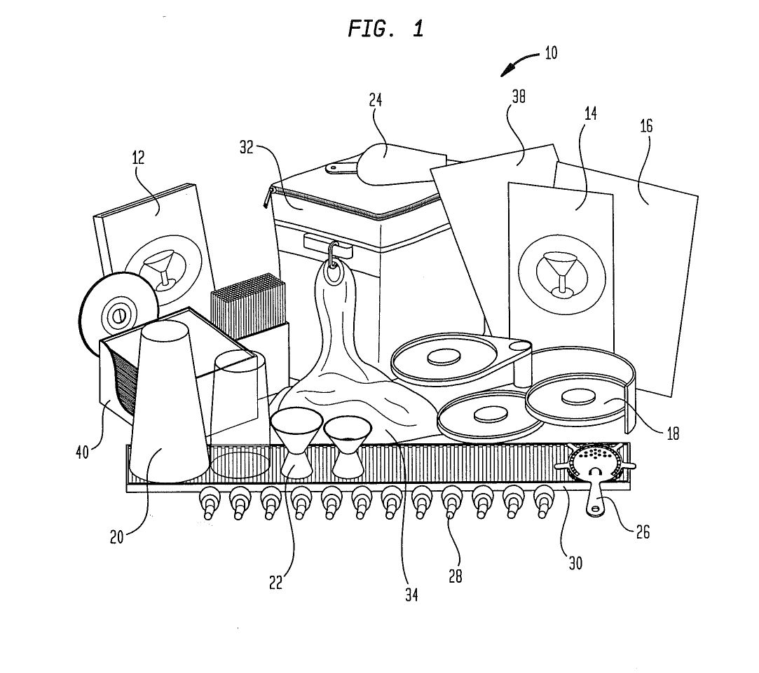

Referring to the drawings, wherein like reference numerals represent like elements, there is shown in FIG. 1, in accordance with a preferred embodiment of the present invention, a bartending (or mixology) kit, designated generally by reference numeral 10. In one embodiment, mixology kit 10 includes an instructional DVD 12 and various mixology tools including, a drink menu 14, a quick reference sheet 16, a margarita salter 18, a mixing tin 20, at least one jigger 22, an ice scoop 24, a strainer 26, a plurality of pour spouts 28, bar mat 30, ice bag 32, bar towel 34, mixing glass 36, ingredient list 38, and napkin caddy 40. In alternate embodiments, it is contemplated that mixology kit 10 can include any combination or quantity of the above mentioned elements. Similarly, it is also contemplated that mixology kit 10 is not limited to the above mentioned elements and can include additional articles.

Each of the previously discussed mixology tools are well known to those of ordinary skill in the art. For example, all with the possible exception of instructional DVD 12 and quick reference sheet 16, are typically found in a professional bar. Similarly, many of the tools would be found in a personal “at home” bar. For example, many personal home bars will have a mixing tin 20 and a strainer 26. However, the combination of the various tools in the kit coupled with instructional DVD 12 and quick reference sheet 16 provides a novel kit for at home bartending.

Instructional DVD 12 is a visual mixology course aimed at teaching a student the art of mixology, while utilizing selected basic materials. It is contemplated that instructional DVD 12 is merely one recordable format for presenting this information. Other formats are contemplated. For example, such information can be conveyed to a student through the use of a VHS tape, CD-ROM, mini disc, audio cassette, or printed publication, to name a few. Regardless of the medium, this instructional set provides instruction for mixing a multitude of mixed drinks, while making use of a small quantity of bottles of drinkable alcohol and selected basic mixology tools.

In accordance with a preferred embodiment of the present invention, it has been found that an overwhelming majority of the most popular mixed drinks can be taught and made utilizing a small quantity of bottles of drinkable alcohol. This both simplifies the teaching of mixology and allows a user to stock a personal bar for a fraction of the cost. For example, in utilizing six bottles of drinkable alcohol including bottles of vodka, gin, tequila, rum, bourbon, and triple sec, in conjunction with other non-alcoholic beverages (generally inexpensive) and several typical mixology tools, a user can mix at least 60 drinks. The small number of bottles of drinkable alcohol makes for an easier learning process and also reduces the cost of stocking a personal bar. With the most popular mixed drinks being represented in the list of at least 60, the additional few, often taught in mixology course and rarely made thereafter, are weeded out.

A method of teaching mixology will now be described in connection with a preferred embodiment of the present invention. In this preferred method, only six bottles of drinkable alcohol are utilized including a bottle of vodka, gin, tequila, rum, bourbon, and triple sec. The six bottles of drinkable alcohol are used along with other non-alcoholic beverages, and in some drinks, garnishes. In the preferred method, a student is taught to mix nearly 70 well known mixed drinks including the following drinks denoted by their well known monikers: a cosmopolitan, bloody mary, long island iced tea, long beach iced tea, bay breeze, sea breeze, cape codder, madras, screwdriver, martini straight up, extra dry martini, martini on the rocks, gibson, salty dog, greyhound, vodka collins, gimlet straight up, gimlet on the rocks, kamikaze, cranberry tart, vodka tonic, vodka and club soda, vodka and coke, vodka and diet coke, vodka and sprite, vodka and cranberry juice, vodka and pineapple juice, tom collins, tanqueray cooler, tangueray bloody mary, tanqueray and tonic, tanqueray and orange juice, frozen lime margarita, frozen strawberry margarita, tequila sunrise, sunburn, margarita on the rocks, margarita straight up, grapefruit blast, tequila gimlet, tequila and orange juice, tequila and grapefruit juice, pina colada, strawberry pina colada, frozen strawberry daiquiri, rum cooler, mai tai, daiquiri rocks, rum cocktail, rum and coke, rum and diet coke, rum and sprite, rum bloody mary, rum and orange juice, rum and cranberry juice, rum and pineapple juice, lynchburg lemonade, whiskey sour, manhattan straight up, manhattan on the rocks, dry manhattan, whiskey and coke, whiskey and diet coke, whiskey and sprite, whiskey and water, whiskey and club soda, and cranberry tart. However, it should be noted that in other embodiments, different bottles of drinkable alcohol can be utilized to mix different mixed drinks. Furthermore, more or less bottles of drinkable alcohol can be used to teach more or less mixed drinks.

The method according to the preferred embodiment of the present invention allows a user to be taught to make 10 times the amount of mixed drinks as bottles of alcohol the user utilizes. The instructional DVD 12 includes audio/visual lessons for making a plurality of drinks, as well as introductory lessons regarding the basic techniques of mixology. The lessons are separate and organized into an interactive menu from which a user can choose one or more lessons to watch. For example, from the interactive menu, the user can select to watch a lesson regarding the basic use of the various mixology tools or instruction as to how to prepare an individual drink. Furthermore, the instructional DVD 12 is to be used in conjunction with quick reference sheet 16. Reference sheet 16 includes instructions for various drinks, which are also taught on instructional DVD 12. In essence, quick reference sheet 16 is the written equivalent of instructional DVD 12, for a selected group of mixed drinks. This is useful for situations where an audio/visual component such as a DVD player and/or TV is not available. Finally, ingredient list 38 provides a “shopping list” of ingredients that a user should purchase in order to mix all of the above stated drinks. As mentioned above, in accordance with the present invention, this “shopping list” is relatively small considering the amount of drinks that can be made.

Each drink lesson takes the student through the steps required to mix the selected mixed drink. The student is instructed to select the proper tools, which alcohols to mix, and which other ingredients are required for the drink. For example, the student can be taught to mix a frozen margarita. The tools utilized to make this drink include margarita salter 18, jiggers 22, ice scoop 24, and a typical household blender. The drinkable alcohols needed to make this drink include tequila and triple sec. Furthermore, the other ingredients include salt, lime juice, and sweet and sour mix.

The first step teaches the student to coat the rim of a glass with salt. The student is instructed to utilize margarita salter 18 by placing the rim of the glass into the sponge portion of the salter, which contains a liquid (e.g. lime juice), and then into the salt portion of the salter. The glass now contains a lip with salt around its rim.

Next, the student is instructed to put a proportioned amount of ice, tequila, triple sec, lime juice and sweet and sour mix into the blender. The ice scoop 24 is utilized to allow the user to put ice in the blender. Likewise, jiggers 22 are used to measure the proper amount of liquid to be placed in the blender. For example, the half ounce side of the jigger is used to measure the proper amount of triple sec (i.e. a half ounce). The other amounts are a half ounce of lime juice, one and a quarter ounces of tequila and four ounces of sweet and sour mix, which are measured using the proper sides of jiggers 22.

The student is then instructed to blend the ingredients together using the blender. Finally, the student is instructed to pour the contents of the blender into the previously salted glass and to add a lime wheel garnish. It should be noted that the previous discussion only pertains to one of many mixed drinks that can be made in accordance with the present invention. However, the present invention contemplates teaching a student to make a plurality of such drinks.

The introductory lessons regarding the basic techniques of mixology include teachings on the mechanics of bartending. For example, some of the lessons include teachings on the proper method of pouring a drink, how to salt a glass, and how to shake a drink, among others. Additionally, the student is taught the art of providing and preparing garnishes, such as lime wheels, lemon twists, orange slices, pineapple wedges, cherries, olives, and onions. In this introductory section, a user is taught the foundation needed for properly preparing the various mixed drinks discussed above.

The present invention simplifies the teaching and learning of mixology. The full spectrum of mixed drinks and drinkable alcohol is vast. Theoretically, the amount of mixed drinks that can be made from the entire catalog of drinkable alcohol is infinite. The present invention teaches a user to make a majority of the most popular mixed drinks (i.e. those that are most frequently ordered) utilizing the most popular bottles of drinkable alcohol (i.e. vodka, gin, tequila, rum, bourbon, and triple sec). Never has there been a simplified course in mixology such as this before.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A mixology teaching kit comprising:
a. an instruction set for teaching a student to prepare a large quantity of mixed drinks utilizing no more than six bottles of drinkable alcohol; and
b. at least one mixology tool.

2. The mixology teaching kit of claim 1, wherein said instruction set is an audio/visual instruction set.

3. The mixology teaching kit of claim 1, wherein said six bottles of drinkable alcohol are from the group consisting of vodka, gin, tequila, rum, bourbon, and triple sec.

4. The mixology teaching kit of claim 1, wherein said large quantity of mixed drinks comprises a cosmopolitan, bloody mary, long island iced tea, long beach iced tea, bay breeze, sea breeze, cape codder, madras, screwdriver, martini straight up, extra dry martini, martini on the rocks, gibson, salty dog, greyhound, vodka collins, gimlet straight up, gimlet on the rocks, kamikaze, vodka tonic, vodka and club soda, vodka and coke, vodka and diet coke, vodka and sprite, vodka and cranberry juice, vodka and pineapple juice, tom collins, tanqueray cooler, tanqueray bloody mary, tanqueray and tonic, tanqueray and orange juice, frozen lime margarita, frozen strawberry margarita, tequila sunrise, sunburn, margarita on the rocks, margarita straight up, grapefruit blast, tequila gimlet, tequila and orange juice, tequila and grapefruit juice, pina colada, strawberry pina colada, frozen strawberry daiquiri, rum cooler, mai tai, daiquiri rocks, rum cocktail, rum and coke, rum and diet coke, rum and sprite, rum bloody mary, rum and orange juice, rum and cranberry juice, rum and pineapple juice, lynchburg lemonade, whiskey sour, manhattan straight up, manhattan on the rocks, dry manhattan, whiskey and coke, whiskey and diet coke, whiskey and sprite, whiskey and water, whiskey and club soda, and cranberry tart.

5. The mixology teaching kit of claim 1, further comprising:
a. an audio/visual instruction set;
b. a drink menu;
c. an ingredient list;
d. a quick reference sheet for instruction on making mixed drinks;
e. a margarita salter;
f. a mixing tin;
g. at least one jigger;
h. an ice scoop;
i. a strainer;
j. at least one pour spout;
k. a bar mat;
l. an ice bag
m. a napkin caddy; and
n. a bar towel.

6. A mixology teaching kit comprising:
a. an instruction set for teaching a student to prepare a quantity of mixed drinks utilizing a plurality of bottles of drinkable alcohol; and
b. at least one mixology tool, wherein said quantity of mixed drinks is at least four times said plurality of bottles of drinkable alcohol.

7. The mixology teaching kit according to claim 6, wherein said quantity of mixed drinks comprises at least six times the quantity of said bottles of drinkable alcohol.

8. The mixology teaching kit according to claim 6, wherein said quantity of mixed drinks comprises at least ten times the quantity of said bottles of drinkable alcohol.

9. The mixology teaching kit according to claim 6, wherein said plurality of bottles of drinkable alcohol is six bottles.

10. The mixology teaching kit of claim 9, wherein said six bottles of drinkable alcohol are from the group consisting of vodka, gin, tequila, rum, bourbon, and triple sec.

11. The mixology teaching kit of claim 6, further comprising:
a. an audio/visual instruction set;
b. a drink menu;
c. an ingredient list;
d. a quick reference sheet for instruction on making mixed drinks;
e. a margarita salter;
f. a mixing tin;
g. at least one jigger;
h. an ice scoop;
i. a strainer;
j. at least one pour spout;
k. a bar mat;
l. an ice bag
m. a napkin caddy; and
n. a bar towel.

12. The mixology teaching kit of claim 6, wherein said quantity of mixed drinks comprises a cosmopolitan, bloody mary, long island iced tea, long beach iced tea, bay breeze, sea breeze, cape codder, madras, screwdriver, martini straight up, extra dry martini, martini on the rocks, gibson, salty dog, greyhound, vodka collins, gimlet straight up, gimlet on the rocks, kamikaze, vodka tonic, vodka and club soda, vodka and coke, vodka and diet coke, vodka and sprite, vodka and cranberry juice, vodka and pineapple juice, tom collins, tanqueray cooler, tangueray bloody mary, tanqueray and tonic, tanqueray and orange juice, frozen lime margarita, frozen strawberry margarita, tequila sunrise, sunburn, margarita on the rocks, margarita straight up, grapefruit blast, tequila gimlet, tequila and orange juice, tequila and grapefruit juice, pina colada, strawberry pina colada, frozen strawberry daiquiri, rum cooler, mai tai, daiquiri rocks, rum cocktail, rum and coke, rum and diet coke, rum and sprite, rum bloody mary, rum and orange juice, rum and cranberry juice, rum and pineapple juice, lynchburg lemonade, whiskey sour, manhattan straight up, manhattan on the rocks, dry manhattan, whiskey and coke, whiskey and diet coke, whiskey and sprite, whiskey and water, whiskey and club soda, and cranberry tart.
